(19) United States
(12) Patent Application Publication
(10) Pub. No.: US 2016/0321346 A1
(43) Pub. Date: Nov. 3, 2016

(54) Clustering Search Results

(71) Applicants: Kevin A. Li, New York, NY (US); Anthony Ko-Ping Chien, Foster City, CA (US)

(72) Inventors: Kevin A. Li, New York, NY (US); Anthony Ko-Ping Chien, Foster City, CA (US)

(21) Appl. No.: 15/138,364

(22) Filed: Apr. 26, 2016

Related U.S. Application Data
(60) Provisional application No. 62/155,549, filed on May 1, 2015.

(51) Int. Cl. G06F 17/30

(52) U.S. Cl. CPC G06F 17/30598; G06F 17/30867; G06F 17/30554; G06F 17/30528

(57) ABSTRACT

Methods, systems, and products cluster search results according to a common clustering parameter. A database of content associates different website links to different classifications of subject matter. The database of content, however, also associates each website link to one or more clustering parameters. When the database of content is queried for the subject matter, search results may be arranged into different clusters according to different clustering parameters.

### CROSS-REFERENCE TO RELATED APPLICATIONS

This application claims the benefit of U.S. Provisional Application 62/155,549 filed May 1, 2015. This application also relates to U.S. application Ser. No. 14/991,079 filed Jan. 8, 2016 and to U.S. application Ser. No. 15/055,917 filed Feb. 29, 2016. All these applications are incorporated herein by reference in their entireties.

### BACKGROUND

Nearly everyone searches the Internet. Some searches, though, may yield thousands or even millions of different results. Such a large corpus of search results is too difficult for most people to manage.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIG. 1 is a simplified schematic illustrating an environment in which exemplary embodiments may be implemented;

FIGS. 2-3 are screen shots of a webpage having clustering, according to exemplary embodiments;

FIGS. 4-5 are more detailed schematics illustrating the operating environment, according to exemplary embodiments;

FIG. 6 is a schematic further illustrating clustering, according to exemplary embodiments; and

FIG. 7 is a flowchart illustrating a method or algorithm for clustering search results, according to exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

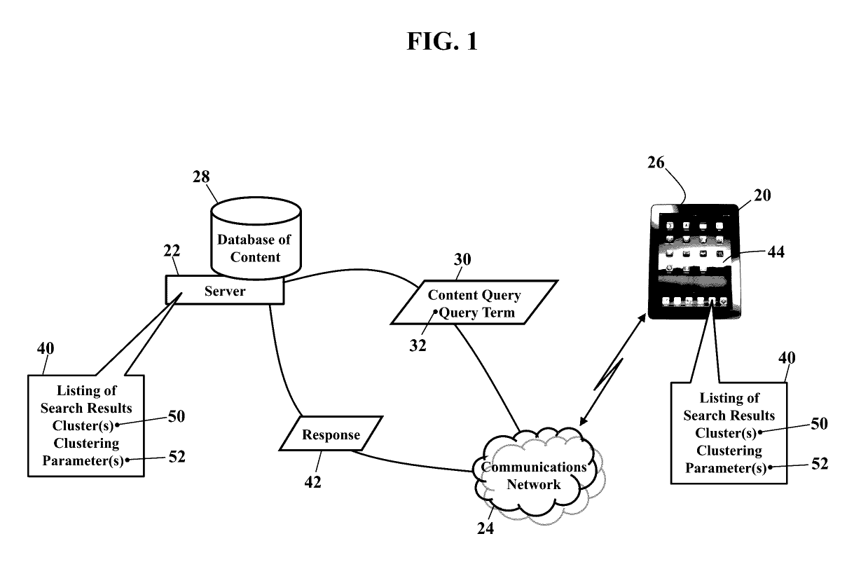

FIG. 1 is a schematic illustrating an environment in which exemplary embodiments may be implemented. FIG. 1 illustrates a client device 20 that communicates with a server 22 via a communications network 24. The client device 20, for simplicity and familiarity, is illustrated as a mobile tablet computer 26. The client device 20, however, may be any other mobile or stationary device, as later paragraphs will explain. Regardless, the server 22 stores a database 28 of content. When a user of the tablet computer 26 wishes to retrieve some subject matter (such as a news article), the user's tablet computer 26 submits a content query 30 to the server 22. The content query 30 includes or specifies a query term 32. The query term 32 is any keyword, subject, or other search term entered by the user. When the server 22 receives the content query 30, the server 22 queries the database 28 of content for the query term 32. The server 22 generates a listing 40 of search results that match the query term 32. The server 22 sends the listing 40 of search results as a response 42 to the network address associated with the tablet computer 26. The tablet computer 26 processes the listing 40 of search results for display on a display device 44. The user of the tablet computer 26 may thus peruse the listing 40 of search results for content related to the query term 32. In a news environment, the listing 40 of search results typically includes news articles and even advertisements that are related to the query term 32.

Here, though, the listing 40 of search results may be organized into clusters 50. As the reader likely understands, some search engines may retrieve hundreds, perhaps even thousands or millions, of entries or documents. Such a massive listing of search results is hopelessly difficult to navigate. Exemplary embodiments, instead, may perform an additional clustering operation to organize the listing 40 of search results. Exemplary embodiments may organize the listing 40 of search results into different groups or clusters 50, according to one or more clustering parameters 52. That is, even though all the entries in the listing 40 of search results may generally relate to the query term 32, the entries in the listing 40 of search results may be further sorted according to the different clustering parameters 52. For example, the listing 40 of search results may be arranged or subcategorized by event, topic, time/date, geographical location, and/or any other clustering parameter 52. All the search results in a single cluster 50 may thus share a common clustering parameter 52. Exemplary embodiments may thus arrange the listing 40 of search results in a much more user-friendly presentation for ease of retrieval.

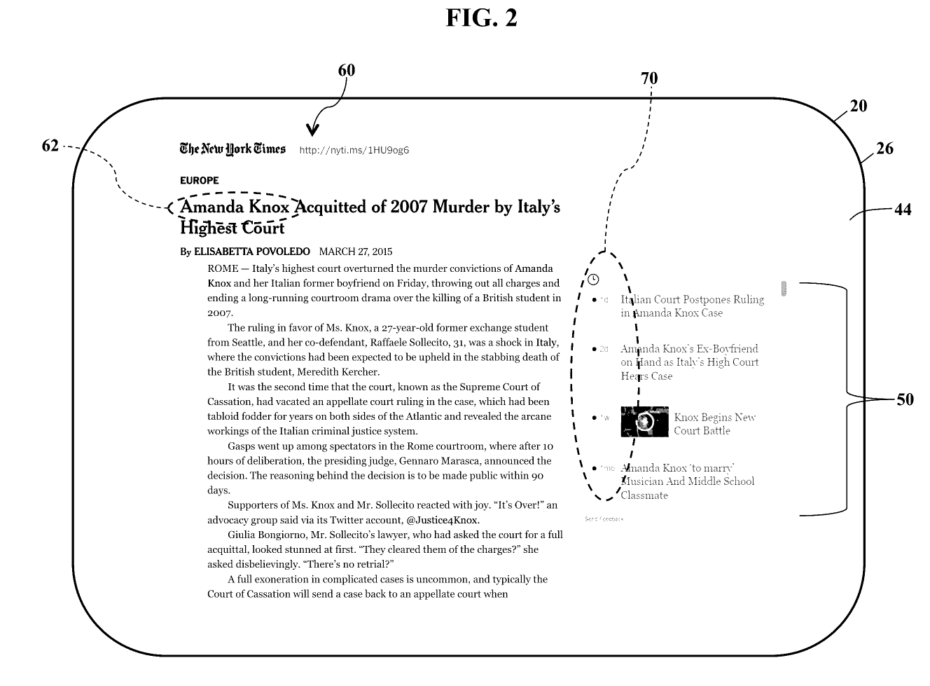

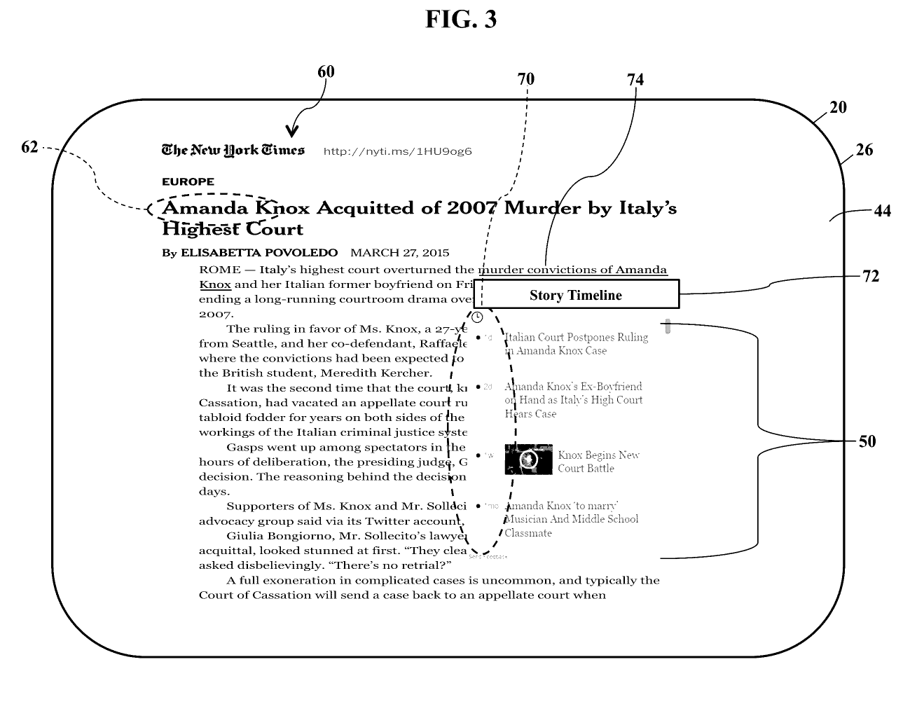

FIGS. 2-3 are screen shots of a webpage 60 having clustering, according to exemplary embodiments. As the reader likely understands, the webpage 60 is an electronic document having text interspersed with formatting instructions (such as Hypertext Markup Language or XHTML). The tablet computer 26 renders the webpage 60 using a software application (such as a web browser). The tablet computer 26 displays the webpage 60 on the display device 44. The webpage 60, when rendered, displays some subject matter 62 (e.g., “Amanda Knox”). FIG. 2, for simplicity and familiarity, illustrates an electronic news article having some relation or categorization to the subject matter 62. The webpage 60 may thus be generated in response to the user's query for the subject matter 62 (e.g., the query term 32 illustrated in FIG. 1). Exemplary embodiments, though, may also present the cluster 50 of related news articles. That is, the cluster 50 displays website links (or uniform resource locators) to additional webpages that also have a relation to the same subject matter 62. In FIG. 2 the entries in the cluster 50 are arranged according to time, thus presenting a historical timeline 70 of events relayed to the subject matter 62. FIG. 2 illustrates the timeline 70 of events as a separate sidebar graphical widget that is incorporated into, or overlaid onto, the electronic content of the webpage 60. While FIG. 2 illustrates the timeline 70 of events presented along a right side area or edge of the webpage 60, exemplary embodiments may arrange or place the timeline 70 of events to any desired location, point, and/or coordinates within the webpage 60.

The timeline 70 of events thus presents an historical arrangement of contextual information. Whatever the subject matter 62 of the webpage 60, exemplary embodiments may display related or contextual information in the timeline 70 of events. In FIG. 2, for example, the timeline 70 of events presents one or more website links to related news articles having the same or similar subject matter 62 (e.g., “Amanda Knox”), albeit arranged according to the clustering parameter 52 of time. Exemplary embodiments, in other words, may cluster the related webpage links in chronological order. This chronological arrangement allows the reading user to quickly delve into historical articles and details for a much quicker historical context. However, exemplary embodiments may arrange the related website links according to any other clustering parameter 52 (such as a geographical location, scholarly contribution, intellectual advancement).

FIG. 3 illustrates an inline presentation. Here exemplary embodiments may display the timeline 70 of events inline with the electronic text of the webpage 60. FIG. 3, for example, illustrates the timeline 70 of events as a popup window widget 72. Some text (such as a phrase 74) may be triggerable or actionable to retrieve and generate the timeline 70 of events. For example, when a finger or cursor locationally hovers on or over the phrase 74, exemplary embodiments may display the timeline 70 of events within the webpage 60. FIG. 3 illustrates the timeline 70 of events overlaid on or above the text of the webpage 60, thus perhaps focusing the reader's attention to the related website links. The timeline 70 of events may thus be displayed for quick and short, fluid cursor or finger movement from the location of the triggerable phrase 74. As the reader's finger or the cursor move away from the triggerable phrase 74, exemplary embodiments may quit or cease display of the timeline 70 of events. Moreover, display of the timeline 70 of events may timeout after a timer counts down to some final value. The triggerable phrase 74 may be identified using any method or scheme (such as single or double underlining, superscript arrow, icon, background coloring, highlighting, and/or text coloring). Based on features as output from a machine learning classifier (i.e. 2-grams, 3-grams, etc) exemplary embodiments may identify which particular phrases should be triggerable.

The timeline 70 of events may include any information. For example, the website links may reveal context in a number of forms such as a textual summary (manually or automatically generated), list of links (internal to the publisher site or external facing), a description generated via crowdsourcing, and even multimedia content (video, audio, photos, any of which can be either algorithmically stitched together or manually curated).

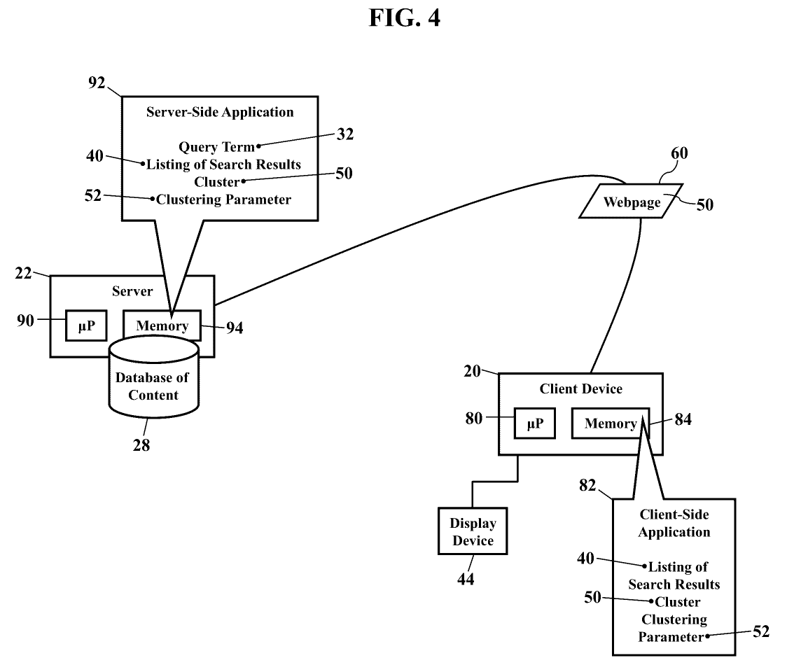

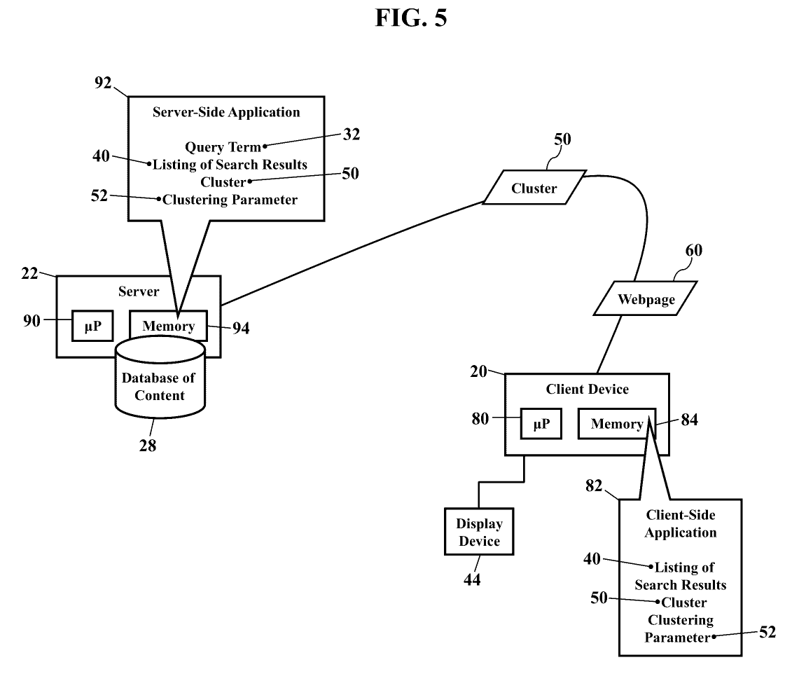

FIGS. 4-5 are more detailed schematics illustrating the operating environment, according to exemplary embodiments. Here the client device 20 is generically illustrated as any system or device having a processor 80 (e.g., “μP”), application specific integrated circuit (ASIC), or other component that executes a client-side application 82 stored in a local memory 84. The client-side application 82 may cause the processor 80 to generate the webpage 60 that is displayed on the display device 44 (such as a capacitive touch screen on the tablet computer 26 illustrated in FIG. 1). The server 22 may also have a processor 90 (e.g., “μP”), application specific integrated circuit (ASIC), or other component that executes a server-side application 92 stored in a local memory 94. The client-side application 82 and/or the server-side application 92 include algorithms, instructions, code, and/or programs that cooperate and to perform operations, such as generating the cluster 50 according to the clustering parameter 52.

Exemplary embodiments generate the clusters 50. When the server 20 queries the database 28 of content for the query term 32, the server 22 generates the listing 40 of search results. As the reader likely understands, some search engines may retrieve hundreds, perhaps even thousands or millions, of entries or documents. Exemplary embodiments may thus perform an additional clustering operation to organize the listing 40 of search results according to the one or more clustering parameters 52. The server-side application 92 may use the clustering parameter 52 to organize the listing 40 of search results into the different groups or clusters 50. That is, even though the listing 40 of search results may all have the same or similar subject matter (according to the query term 32), the entries in the listing 40 of search results may be further sorted according to the different clustering parameters 52. For example, the listing 40 of search results may be arranged or subcategorized by event, subtopic, time/date, geographical location, and/or any other clustering parameter 52. All the search results in a single cluster 50 may thus share a common clustering parameter 52.

As FIG. 4 illustrates, each cluster 50 may then be rendered for presentation. The server 22, for example, may incorporate the clusters 50 into the webpage 60. That is, when the server 22 retrieves the webpage 60, the server-side application 92 may add or inject each cluster 50 into the formatting defined by the hypertext markup language. When the webpage 60 is sent to the network address associated with the client device 20, the webpage 60 may thus include the clusters 50 that provide additional, historical context.

FIG. 5, though, illustrates separate delivery of the clusters 50. The client device 20 may receive the webpage 60 and separately receive one or more of the clusters 50. When the web browser at the client device 20 renders the webpage 60 for display, the web browser may inject the clusters 50 into the webpage 60. Once the clusters 50 are determined, exemplary embodiments may inject this additional, historical context into the presentation layer before rendering the webpage 60.

Clustering may be based on location. When the client device 20 sends the query term 32, the client device 20 may also send or include its current location. For example, the mobile tablet computer 26, mobile smartphones, and many other electronic devices have a global positioning system receiver that receives GPS coordinates or information. The client device 20 may thus include its current location when querying for the query term 32. When the server 20 queries the database 28 of content for the query term 32, the server 22 may thus use the current location as one of the clustering parameters 52. The server 20, for example, may cluster the listing 40 of search results according to the current location. Exemplary embodiments may thus organize the listing 40 of search results according to the current location reported by the client device 22. The search results, for example, may be clustered according to a radial distance from the current location reported by the client device 22. The geographically closest search results, for example, may be grouped together in a first cluster 50. Search results farther away (perhaps outside a 5-mile threshold radius) may be grouped together in a second cluster 50. Exemplary embodiments may continue thus clustering using different threshold radii from the current location reported by the client device 22.

Clustering, however, may be based on any location. Exemplary embodiments may generate the clusters 50 based on any location. For example, when the client device 20 sends the query term 32, the user of the client device 20 may also specify any geographic location of interest, regardless of the current location of the client device 22. For example, a user interface may permit textual entry of the desired locational clustering parameter 52, such as “Times Square.” The user may even specify multiple geographic locations, thus clustering the search results for each one of the geographic locations.

Exemplary embodiments may packetize. The client device 20 and the server 22 have one or more network interfaces to the communications network 24. The network interface may packetize communications or messages into packets of data according to a packet protocol, such as the Internet Protocol. The packets of data contain bits or bytes of data describing the contents, or payload, of a message. A header of each packet of data may contain routing information identifying an origination address and/or a destination address. There are many different known packet protocols, and the Internet Protocol is widely used, so no detailed explanation is needed.

Exemplary embodiments may be applied regardless of networking environment. Exemplary embodiments may be easily adapted to stationary or mobile devices having cellular, WI-FI®, near field, and/or BLUETOOTH® capability. Exemplary embodiments may be applied to mobile devices utilizing any portion of the electromagnetic spectrum and any signaling standard (such as the IEEE 802 family of standards, GSM/CDMA/TDMA or any cellular standard, and/or the ISM band). Exemplary embodiments, however, may be applied to any processor-controlled device operating in the radio-frequency domain and/or the Internet Protocol (IP) domain. Exemplary embodiments may be applied to any processor-controlled device utilizing a distributed computing network, such as the Internet (sometimes alternatively known as the “World Wide Web”), an intranet, a local-area network (LAN), and/or a wide-area network (WAN). Exemplary embodiments may be applied to any processor-controlled device utilizing power line technologies, in which signals are communicated via electrical wiring. Indeed, exemplary embodiments may be applied regardless of physical componentry, physical configuration, or communications standard(s).

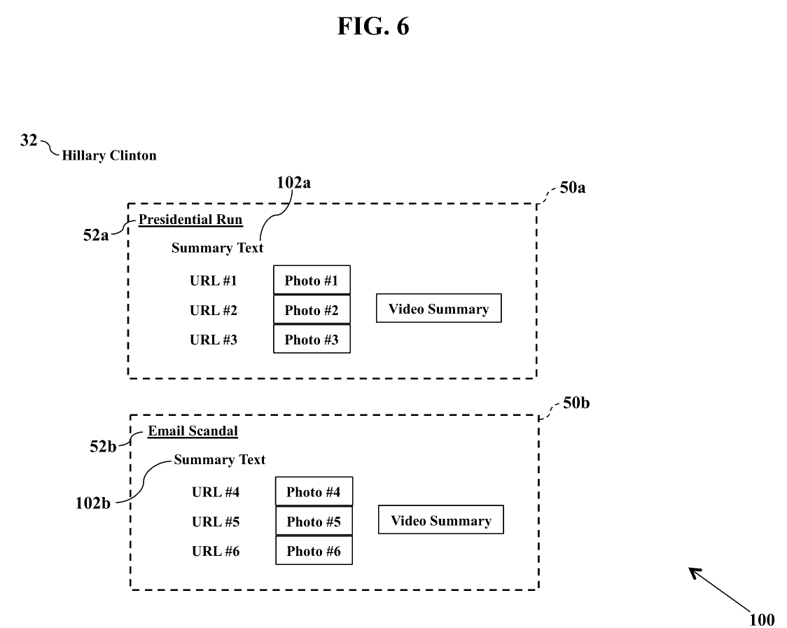

FIG. 6 is a schematic further illustrating clustering, according to exemplary embodiments. FIG. 6 illustrates a tile-based graphical user interface 100 for viewing search results. This layout approach organizes search results into the different clusters 50 according to different clustering parameters 52. For example, suppose a user queries for “Hillary Clinton” (the query term 32 illustrated in FIG. 1). Exemplary embodiments may thus present a first cluster 50a having the search results clustered under “Presidential Run.” That is, exemplary embodiments may subgroup the website links, photos, and videos according to the clustering parameter 52a of “presidential run.” Exemplary embodiments may even generate and display summary text 102a that summarizes the clustering parameter 52a of “presidential run.” FIG. 6 illustrates a second cluster 50b having the search results clustered under “Email Scandal.” The second cluster 50b thus arranges the summary text 102b, website links, photos, and videos that are all related to the clustering parameter 52b of “Email Scandal.” As the query term “Hillary Clinton” may generate thousands or even millions of results, exemplary embodiments may cluster the search results into several, or even many, different clusters 50. In practice the number of clusters 50 may be limited to some smaller amount, such as the most general clustering parameters 52 or the most popular five (5) clusters 50.

Clustering thus improves search results. Clustering is especially useful as displays become larger (wider) whereby a long, scrollable list becomes increasingly difficult to use. Additionally, clustering is useful on smaller displays whereby targets (in this case the clickable targets that represent clusters of result sets) need to be of a size appropriate for human interaction; thin rectangles are harder to tap than squares. Despite higher display resolutions, human fingers are not getting any smaller.

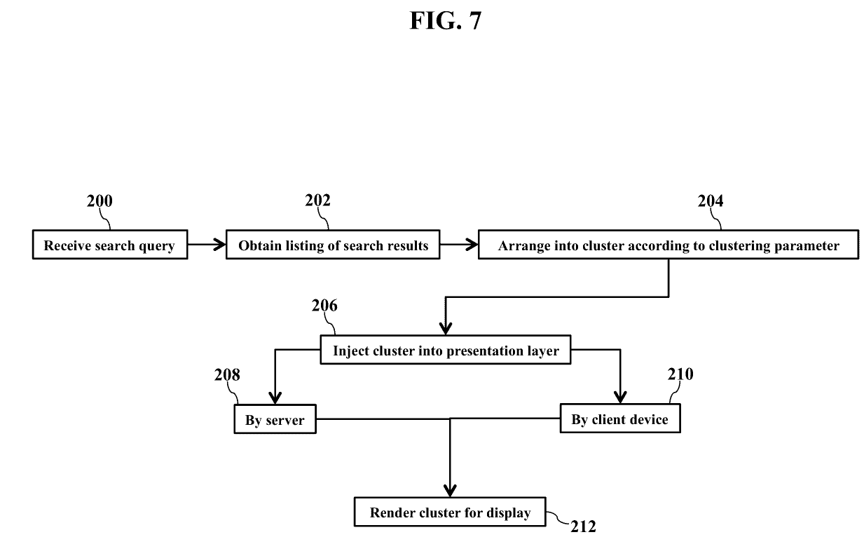

FIG. 7 is a flowchart illustrating a method or algorithm for clustering search results, according to exemplary embodiments. The search query 32 is received (Block 200). The database 28 of content is searched and the listing 40 of search results is obtained (Block 202). The entries in the listing 40 of search results are arranged into the clusters 50 according to the clustering parameters 52 (Block 204). The clusters 50 are injected into a presentation layer of the webpage 60 (Block 206) by the web browser of the client device 20 (Block 208) or by the server 22 (Block 210). The clusters 50 are then rendered for display (Block 212).

Exemplary embodiments may be physically embodied on or in a processor-readable device or storage medium. For example, exemplary embodiments may include CD-ROM, DVD, tape, cassette, floppy disk, optical disk, memory card, memory drive, and large-capacity disks.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

1. A method, comprising:
receiving, by a server, an electronic content query sent via the Internet from a client device, the electronic content query specifying a search term for an Internet search engine;
querying, by the server, an electronic database of content for the search term, the electronic database of content having electronic database associations between website links and search terms including the search term specified by the electronic content query;
retrieving, by the server, Internet search results from the electronic database of content, the Internet search results including the website links having an electronic database association with the search term specified by the electronic content query;
sending, by the server, the Internet search results to the client device in response to the electronic content query specifying the search term; and
providing, by the server, a web browser via the Internet to the client device, the web browser clustering the website links according to an additional clustering parameter, such that the website links having a common association with both the search term and with the clustering parameter are visually arranged as a group.

2. The method of claim 1, further comprising clustering the website links in the Internet search results according to a geographical location as the clustering parameter.

3. The method of claim 1, further comprising chronologically arranging the website links in the Internet search results.

4. The method of claim 1, further comprising arranging the website links in the Internet search results according to a date and time as the clustering parameter.

5. The method of claim 1, further comprising arranging the website links in the Internet search results according to an event as the clustering parameter.

6. The method of claim 1, further comprising arranging the website links in the Internet search results according to different events, each event of the different events being the clustering parameter.

7. The method of claim 1, further comprising arranging the website links in the Internet search results according to scholarly contribution as the clustering parameter.

8. A system, comprising:
a processor; and
a memory device, the memory device storing instructions, the instructions when executed causing the processor to perform operations, the operations comprising:
receiving an electronic rich site summary feed via the Internet, the electronic rich site summary feed comprising an electronic news article;
parsing text associated with the electronic news article in the electronic rich site summary feed received via the Internet;
classifying the text according to a subject matter;
adding a website link to an electronic database of content, the electronic database of content having electronic database associations between website links and different subject matter, the electronic database of content adding an entry that electronically associates the website link to the subject matter classified according to the text;
receiving an electronic content query sent via the Internet from a client device, the electronic content query specifying a search term for an Internet search engine;
querying the electronic database of content for the search term specified by the electronic content query;
retrieving Internet search results from the electronic database of content, the Internet search results including the website links having an electronic database association with the search term specified by the electronic content query;
sending the Internet search results via the Internet to the client device in response to the electronic content query specifying the search term; and
providing a web browser via the Internet to the client device, the web browser clustering the website links according to an additional clustering parameter, such that the website links in the Internet search results having a common association with both the search term and with the clustering parameter are visually arranged as a separate group from other website links in the Internet search results that are unassociated with the clustering parameter.

9. The system of claim 8, wherein the operations further comprise clustering the website links in the Internet search results according to a geographical location as the clustering parameter.

10. The system of claim 8, wherein the operations further comprise chronologically arranging the website links in the Internet search results.

11. The system of claim 8, wherein the operations further comprise arranging the website links in the Internet search results according to a date and time as the clustering parameter.

12. The system of claim 8, wherein the operations further comprise arranging the website links in the Internet search results according to an event as the clustering parameter.

13. The system of claim 8, wherein the operations further comprise arranging the website links in the Internet search results according to different events, each event of the different events being the clustering parameter.

14. The system of claim 8, wherein the operations further comprise arranging the website links in the Internet search results according to scholarly contribution as the clustering parameter.

15. A memory device storing instructions that when executed cause a processor to perform operations, the operations comprising:
receiving an electronic rich site summary feed via the Internet, the electronic rich site summary feed comprising an electronic news article;
parsing text associated with the electronic news article in the electronic rich site summary feed received via the Internet;
classifying the text according to a subject matter;
adding a website link to an electronic database of content, the electronic database of content having electronic database associations between website links and different subject matter, the electronic database of content adding an entry that electronically associates the website link to the subject matter classified according to the text;
receiving an electronic content query sent via the Internet from a client device, the electronic content query specifying a search term for an Internet search engine;
querying the electronic database of content for the search term specified by the electronic content query;
retrieving Internet search results from the electronic database of content, the Internet search results including the website links having an electronic database association with the search term specified by the electronic content query;
sending the Internet search results via the Internet to the client device in response to the electronic content query specifying the search term; and
providing a web browser via the Internet to the client device, the web browser clustering the website links according to different clustering parameters, such that the website links in the Internet search results having a common association with the search term and with one of the clustering parameters are visually arranged as a separate group from other groups of the website links in the Internet search results that are associated with other ones of the different clustering parameters.

16. The system of claim 15, wherein the operations further comprise clustering the website links in the Internet search results according to a geographical location as the one of the clustering parameters.

17. The system of claim 15, wherein the operations further comprise chronologically arranging the website links in the Internet search results.

18. The system of claim 15, wherein the operations further comprise arranging the website links in the Internet search results according to a date and time as the one of the clustering parameters.

19. The system of claim 15, wherein the operations further comprise arranging the website links in the Internet search results according to an event as the one of the clustering parameters.

20. The system of claim 15, wherein the operations further comprise arranging the website links in the Internet search results according to scholarly contribution as the one of the clustering parameters.
